(19) United States
(12) Patent Application Publication
(10) Pub. No.: US 2008/0061471 A1
(43) Pub. Date: Mar. 13, 2008

(54) Decorative moulding toy

(75) Inventor: Patricia Bradley, Glen Cove, NY (US)

Correspondence Address: COHEN, PONTANI, LIEBERMAN & PAVANE, 551 FIFTH AVENUE, SUITE 1210, NEW YORK, NY, 10176, US

(73) Assignee: Spin Master Ltd.

(21) Appl. No.: 11/520,087

(22) Filed: Sep. 13, 2006

(51) Int. Cl. B29C 45/14

(52) U.S. Cl. 264/279; 425/110

(57) ABSTRACT

A toy is provided employing moldable material and three-dimensional structures having recessed regions for receiving and retaining quantities of the moldable material. The moldable material is releasably attachable to the structure to give the structure a decorative coating. If, after initial attachment, the appearance of moldable material on the structure is unsatisfactory, the moldable material may be removed and reapplied to the same structure or to another structure.

### FIELD OF THE INVENTION

The present invention relates to a toy that can be decorated using a moldable material.

### BACKGROUND

The use of moldable materials in toys and crafts is known in the art. The use of a structure as a base for the application of a moldable material is also known.

For example, International Application No. WO2005/018953, of Cassidy Brothers PLC, discloses an apparatus for creating a sculpture, which includes a base structure. Pegs protrude from the base structure to guide the application of modeling medium to the structure.

U.S. Pat. No. 2,831,286, of J. Eisner, discloses an apparatus for sculpturing that provides a mould for forming facial features, noses, ears, etc., and a base structure designed to receive the molded features. Facial features are first molded and are then attached to the base structure.

U.S. Pat. No. 4,738,647 to Renger et al., discloses a toy where one first forms a toy monster figure by shaping a plastic molding material mixed with sodium bicarbonate powder around a toy skeleton. The molded figure is then dissolved by immersing the monster figure in a diluted citric acid solution.

The above mentioned references disclose the use of a moldable material to create new structures, e.g. figures, faces, etc. However, the final three-dimensional structures contemplated in these patents are formed by a user. The appearance and shape of the final structures will vary based on the skill and imagination of individual users.

### SUMMARY

Accordingly, there is a need to provide a toy which allows the use of a moldable material to decorate structures representing recognizable articles.

There is another need to provide a toy which guides the application of adjustable, moldable decoration to replicas of real and imaginary articles.

There is a further need to provide a structure and a moldable material that can be applied to the structure and then made configurationally stable.

To address these needs, herein is describe a novel decorative molding toy apparatus and method of use wherein a moldable material is used to add decoration to a recognizable three-dimensional structure, for example, a house, an animal, or human figure.

The decorative molding toy employs moldable material and three-dimensional structures having recessed regions for receiving and retaining quantities of the moldable material. The moldable material is releasably attached to the structure to give the structure a decorative coating with a unique texture. If, after initial attachment, the appearance of moldable material on the structure is unsatisfactory, the moldable material may be removed and reapplied to the same structure or to another structure. In one embodiment, when the appearance of moldable material on the structure is satisfactory, the structure may be heated to harden the moldable material into a configurationally stable phase.

According to one aspect, there is provided an apparatus for a decorative molding toy comprising: a three-dimensional structure representing a predetermined object and comprising an external surface; and a moldable material, the moldable material capable of releasable attachment to the external surface; wherein the moldable material is usable to decorate the structure.

According to another aspect, there is provided a method for decorating a structure comprising the step of applying a moldable material to the structure, the moldable material capable of releasable attachment to the structure.

Other objects and features will become apparent from the following detailed description considered in conjunction with the accompanying drawings. It is to be understood, however, that the drawings are designed solely for purposes of illustration and not as a definition of the limits of the decorative molding toy, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a perspective view of a decorative molding toy according to one embodiment;

FIG. 2 is another perspective view of the decorative molding toy of FIG. 1 in a different configuration; and

FIGS. 3a and 3b are front and back views of a decorative molding toy according to another embodiment.

### DETAILED DESCRIPTION

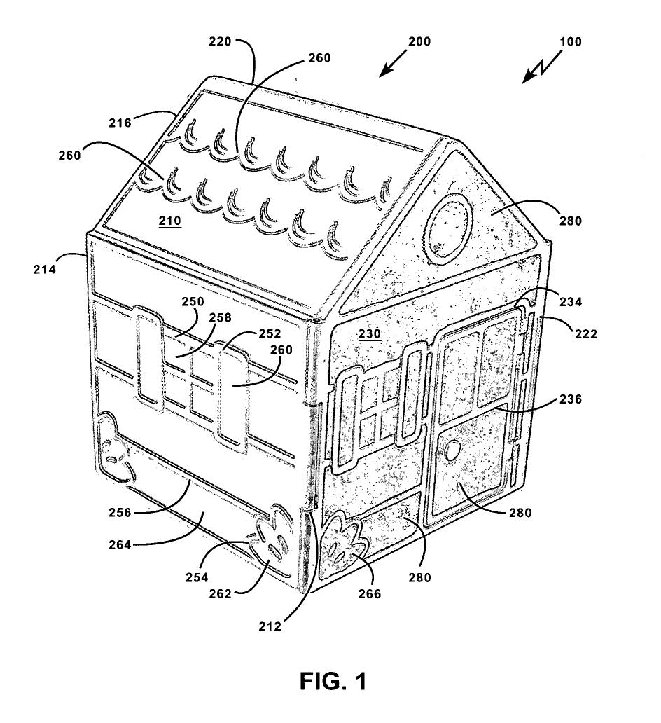

The decorative molding toy 100 generally comprises at least one structure and a quantity of moldable material. With reference to FIG. 1, in one embodiment, structure 200 comprises three solid plastic sections: two side sections 210, 220 and one center section 230. In alternate embodiments, the structure may be formed of any material including plastic, wood, metal, etc. The material used to make structure 200 may be rigid or non-rigid, or any combination thereof.

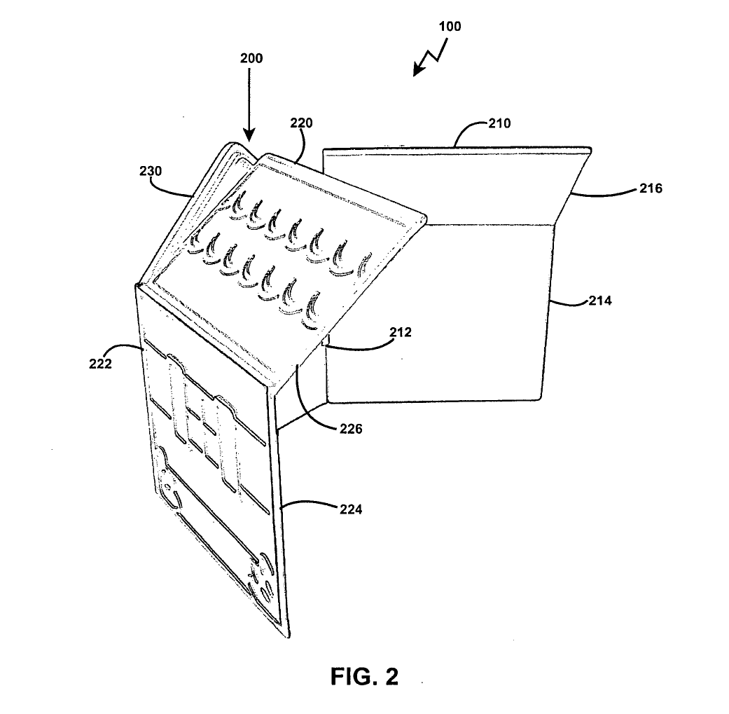

Center section 230 comprises a vertical portion 232 with doorway 234 and door 236 pivotably attached to the doorway. Side sections 210, 220 are pivotably attached by attachment means 212, 222 to opposite sides of center section 230. First side section 210 comprises first vertical portion 214 and first angled portion 216 that extends from the top of first vertical portion. Similarly, second side section 220 (best shown in FIG. 2) comprises second vertical portion 224 and second angled portion 226 that extends from the top of second vertical portion. Side sections 210, 220 may be pivoted around attachment means 212, 222, such that angled portions 216, 226 meet at their highest vertical extent. In this configuration, the side sections 210, 220 and center section 230 form a structure with the appearance of a house, the angled portions 216, 226 of the side sections 210, 220 forming the roof of the house. Side sections 210, 220 may be pivoted around attachment means 212, 224 to form alternate configurations (best shown in FIG. 2) in order to, for example, facilitate storage of structure 200.

Each of side sections 210, 220 and center section 230 of structure 200 include an external surface with integral ridge-like formations that define recessed regions. Generally, the ridge-like formations trace features appropriate to the structure on which they appear. On first vertical portion 214 of first side section 210, the ridge-like formations delineate elements common to the side of a house, for example window ridge 250, window shutter ridge 252, plant ridge 254 and siding panel ridge 256. These ridge-like formations circumscribe corresponding recessed regions, for example window recess 258, window shutter recess 260, plant recess 262 and siding panel recess 264. On first angled portion 216 of side section 210, the ridge-like formations delineate elements common to the roof of a house, for example, roof tile ridge 260.

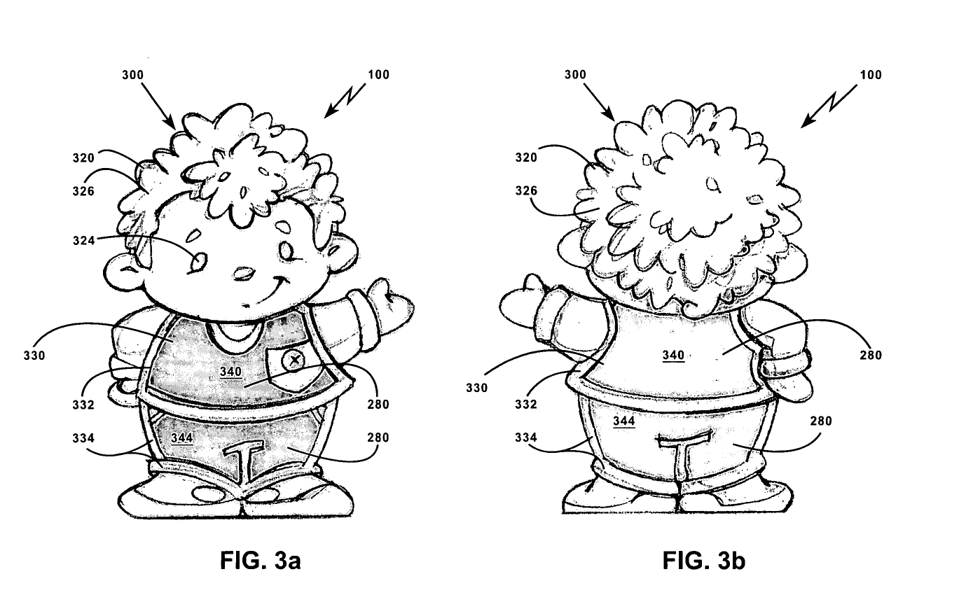

The second major component of decorative molding toy 100 is a quantity of molding material 280, shown in FIG. 1 and FIG. 3 as being applied into the recessed regions circumscribed by the ridge-like formations. The quantity of moldable material comprises any material that can be moulded by hand and is capable of releasable attachment to structure 200. Moldable material 280 may be applied to external surface of structure 200 to add color and texture. In the present embodiment, moldable material comprises portions of different colors. In alternate embodiments, moldable material may comprise portions with several different physical characteristics, e.g. color, consistency, etc.

The moldable material 280 may comprise a composition of a sand-like material and a binding agent with formability properties comparable to wet sand, such as the materials disclosed in U.S. Pat. No. 5,711,795 to Browning, and WO 98/41408 to Modell. Advantageously, the moldable material is a material which is of moderate softness for direct use and which maintains approximately the same softness throughout its entire service life, but which also may successfully be hardened in order to maintain the achieved shape. Moreover the moldable material should be suitable to be handled by children. In one embodiment, the moldable material comprises a particulate or granular material and a binder that has two solid phases: a harder, configurationally stable phase and a softer, moldable phase being plastic and readily deformable at temperatures below the melting point of the binder. The binder may have a first component that is synthetic rubber and a second component that is a polymer or a wax. The grain size of the particulate or granular material may be between 0.02 mm and 0.5 mm and preferably between 0.05 and 0.15.

With reference to FIG. 3, in another embodiment, decorative molding toy 100 is a stylized human figure 300, comprising a head 320 and a body 330. The external surface of body 330 has ridge-like formations delineating articles of clothing, for example, shirt ridge 332 and pants ridge 334. The external surface of head 320 has integrated design elements, for example, eyes 324 and hair 326, which are not delineated by ridge-like formations.

As described above with respect to FIG. 1, the ridge-like formations shown in FIG. 3 also circumscribe corresponding recessed regions, for example shirt recess 340, and pants recess 344. The recess 340 and 344 are shown in FIG. 3 to be filled with moldable material 280.

In alternate embodiments, the decorative molding toy 100 may be constructed differently, for example, as a solid block of material. In further alternate embodiments, the decorative molding toy 100 may be a replica of any article, real or imaginary, and the may have any number of integrated design elements, ridge-like formations and recesses.

A description of the operation of the decorative molding toy 100 according to the embodiment shown in FIG. 1 follows. First, a user selects a portion of moldable material 280 to apply to the structure 200. Next, the user presses the portion of moldable material against external surface of the structure 200, attaching the moldable material to the external surface. The moldable material 280 may be pressed against and attached to any part of the external surface of structure 200 or the ridge-like formations on external surface of the structure 200 may be used to guide the application of moldable material. For example, a user may press a portion of green moldable material into plant recess 262 such that plant recess is filled with moldable material, i.e., the surface of green moldable material is level with the top of plant ridge 254 circumscribing plant recess 262. As a result, plant recess 262 would resemble filled recess 266. Other recessed regions of structure 200 may similarly be filled with moldable material of the same or different colors, depending on the desired effect that one wishes to create. For example, yellow moldable material may be applied to window shutter recess 260. Generally, the decorative molding toy 100 as described herein by the applicant is analogous to a three dimensional coloring book, with the advantage, however, that the colors can be changed and revised as desired.

Moldable material applied to structure 200 gives the structure a decorative coating with a unique texture. If the user finds the appearance of moldable material on the structure unsatisfactory for any reason, for example, unappealing color or thickness, moldable material 280 may be removed and reapplied to the structure or replaced with moldable material of a different color.

In one embodiment, when the user is satisfied with the decoration of the structure, the structure and the moldable material may be heated and cooled to harden the moldable material into a configurationally stable phase. In another embodiment, the moldable material may be hardened by the application of a fixing agent on the surface thereof.

Although only a small number of embodiments have been shown and described, it will be appreciated by those skilled in the art that changes may be made in these embodiments without departing from the principles and spirit of the decorative molding toy, the scope of which is defined in the claims and their equivalents.

1. An apparatus for a decorative molding toy comprising:
a three-dimensional structure representing a predetermined object and comprising an external surface; and
a moldable material, said moldable material capable of releasable attachment to said external surface;
wherein said moldable material is usable to decorate said structure.

2. The apparatus of claim 1, wherein said external surface of said structure has guide means constructed thereon for guiding the application of said moldable material thereto.

3. The apparatus of claim 2, wherein said guide means comprise ridge-like formations defining recessed regions.

4. The apparatus of claim 1, wherein said moldable material comprises a composition of a particulate or granular material and a binding agent.

5. The apparatus of claim 1, wherein said moldable material has two solid phases comprising:
a configurationally stable phase; and
a soft, moldable phase.

6. The apparatus of claim 4, wherein the binder has a first component that is synthetic rubber.

7. The apparatus of claim 6, wherein the binder has a second component that is a polymer or a wax.

8. The apparatus of claim 4, wherein the particulate or granular material has a grain size of between 0.02 mm and 0.5 mm.

9. The apparatus of claim 1, wherein said moldable material comprises at least two portions, each of said portions being a different colour.

10. The apparatus of claim 1, wherein said moldable material may be heated and cooled to harden said moldable material into a configurationally stable phase.

11. The apparatus of claim 1, wherein said moldable material may be hardened by the application of a fixing agent on the surface thereof.

12. A method for decorating a structure comprising the step of applying a moldable material to the structure, the moldable material capable of releasable attachment to the structure.

13. The method of claim 12, wherein the structure comprises guide means integral with the structure, said guide means being usable to guide the application of said moldable material to said structure.

14. The method of claim 12, wherein said guide means comprise ridge-like formations defining recessed regions.

15. The method of claim 12, including the steps of heating and cooling the structure and the moldable material after applying the moldable material to the structure, said heating and cooling steps hardening the moldable material into a configurationally stable phase.

16. The method of claim 12, including the step of applying a fixing agent to the surface of the moldable material to harden the moldable material.

17. The method of claim 12, wherein the moldable material comprises at least two portions, each of said portions being a different color.
